(19) United States
(12) Patent Application Publication
(10) Pub. No.: US 2025/0304130 A1
(43) Pub. Date: Oct. 2, 2025

(54) HITCH MOUNTABLE WAGON ASSEMBLY AND METHOD OF MAKING SAME

(71) Applicant: Tail Gator, LP, Sunrise Beach Village, TX (US)

(72) Inventors: Coy Matthew King, Spring Branch, TX (US); Martin Franklin, Sunrise Beach Village, TX (US)

(21) Appl. No.: 19/089,565

(22) Filed: Mar. 25, 2025

Related U.S. Application Data
(60) Provisional application No. 63/569,759, filed on Mar. 26, 2024.

(51) Int. Cl. B62B 3/00; B60R 9/06; B62B 5/06

(52) U.S. Cl. CPC B62B 3/007; B60R 9/06; B62B 5/067; B62B 2301/04; B62B 2301/20

(57) ABSTRACT

A hitch mountable wagon assembly includes a wagon that includes a basket; a frame along a perimeter of the basket; a pair of tubular structures attached underneath a bottom of the basket; an insertion piece attached underneath the bottom of the basket and between the pair of tubular structures; and four retractable wheels mounted at four corners of the frame. The hitch mountable wagon assembly also includes an adapter configured to removably mount the wagon to a hitch receiver of a vehicle. The adapter includes a pair of forks insertable into the pair of tubular structures of the wagon; a first receiver extension between the pair of forks, configured to receive the insertion piece of the wagon; and a second receiver extension receivable by the hitch receiver of the vehicle.

### CROSS-REFERENCE TO RELATED APPLICATIONS

This application claims priority from U.S. Provisional Application No. 63/569,759, filed on Mar. 26, 2024, which is incorporated by reference herein its entirety.

### TECHNICAL FIELD

This technology includes a hitch mountable wagon assembly and method of making same.

### BACKGROUND

Powered and trailed vehicles are conventionally interconnected for travel. There is a need for a hitch mount cargo rack that can also be used as a wagon.

### SUMMARY

A hitch mountable wagon assembly includes a wagon that includes a basket; a frame along a perimeter of the basket; a pair of tubular structures attached underneath a bottom of the basket; an insertion piece attached underneath the bottom of the basket and between the pair of tubular structures; and four retractable wheels mounted at four corners of the frame. The hitch mountable wagon assembly also includes an adapter configured to removably mount the wagon to a hitch receiver of a vehicle. The adapter includes a pair of forks insertable into the pair of tubular structures of the wagon; a first receiver extension between the pair of forks, configured to receive the insertion piece of the wagon; and a second receiver extension receivable by the hitch receiver of the vehicle.

### BRIEF DESCRIPTION OF THE DRAWINGS

FIG. 1 is a perspective view of a hitch adaptor and a hitch mountable wagon assembly, in accordance with one embodiment, showing the hitch mountable wagon assembly with an attachable push handle and two handles on one side or a right side of the hitch mountable wagon assembly.

FIG. 2 is a perspective view of the hitch adaptor and the hitch mountable wagon assembly, in accordance with one embodiment, showing the hitch mountable wagon assembly without the attachable push handle.

FIG. 3 is a perspective view of the hitch adaptor and the hitch mountable wagon assembly, in accordance with one embodiment, showing the hitch mountable wagon assembly without the attachable push handle and without the two handles.

FIG. 4 is a top view of the hitch adaptor and the hitch mountable wagon assembly.

FIG. 5 is a bottom view thereof.

FIG. 6 is a right-side view thereof.

FIG. 7 is a left-side view thereof.

FIG. 8 is a rear view thereof.

FIG. 9 is a front view thereof.

FIG. 10 is a top view of the hitch adaptor and the hitch mountable wagon assembly, in accordance with one embodiment, showing a tapered insertion piece of the hitch mountable wagon assembly receivable by the hitch adaptor.

FIG. 11 is a right-side view of the hitch adaptor and the hitch mountable wagon assembly, in accordance with one embodiment, showing wheels of the hitch mountable wagon in a retracted configuration.

FIG. 12 is a perspective view showing the hitch adaptor, the hitch mountable wagon assembly, and a connector in a configuration of use where the hitch mountable wagon assembly is in a lowered position.

FIG. 13 is a perspective view showing the hitch adaptor, the hitch mountable wagon assembly, and the connector in a configuration of use where the hitch mountable wagon assembly is in a lifted position.

FIG. 14 is a perspective view showing the hitch adaptor and the connector in a configuration of use where the hitch mountable wagon assembly is in a lifted position.

FIG. 15 shows an image of an exemplary retractable wheel of the hitch mountable wagon assembly.

### DETAILED DESCRIPTION

The present disclosure is directed to a hitch mountable wagon assembly or a wagon assembly 100 that can be secured to a vehicle 102 for transportation from one location to another. The wagon assembly 100 is secured to the vehicle 102 by connecting the wagon assembly 100 to a trailer hitch receiver or a hitch receiver 104. The wagon assembly 100 includes two separate components: a wagon 106 and a hitch adapter 108. One end of the hitch adapter 108 can be secured to the wagon 106 and the other end can be secured to the hitch receiver 104 of the vehicle 102.

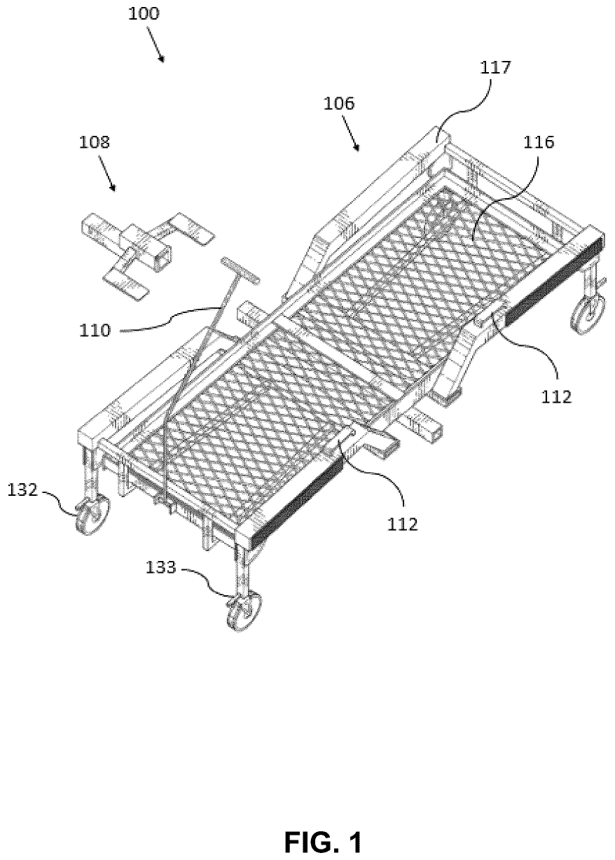

FIG. 1 is a perspective view of the wagon 106 and the hitch adaptor 108, in accordance with one embodiment, showing the wagon 106 with an attachable push handle 110 and one or more handles 112 on one side or a right side of the wagon assembly 100. In one embodiment, the push handle 110 is removably coupled to the wagon 106 and can pivot relative to the wagon 106.

The wagon 106 includes a basket 116, side rails 117, and four retractable wheels 132. Each of the four retractable wheels 132 may include a handle 133 for ease of maneuverability to move the four retractable wheels 132 between a fully retracted position and a fully extended position. A spring and lock mechanism may be used to secure the four retractable wheels 132 in both the retracted and extended positions. The four retractable wheels 132 can be permanently fixed to the underside of the wagon 106 and the front two wheels can be arranged to pivot or rotate (for changing directions) for ease of maneuverability. In some embodiments, only the front two retractable wheels 132 (e.g., the retractable wheels 132 closer to the attachable push handle 110) are able to pivot or rotate (for changing directions). In some embodiments, all four of the retractable wheels 132 are able to pivot or rotate (for changing directions).

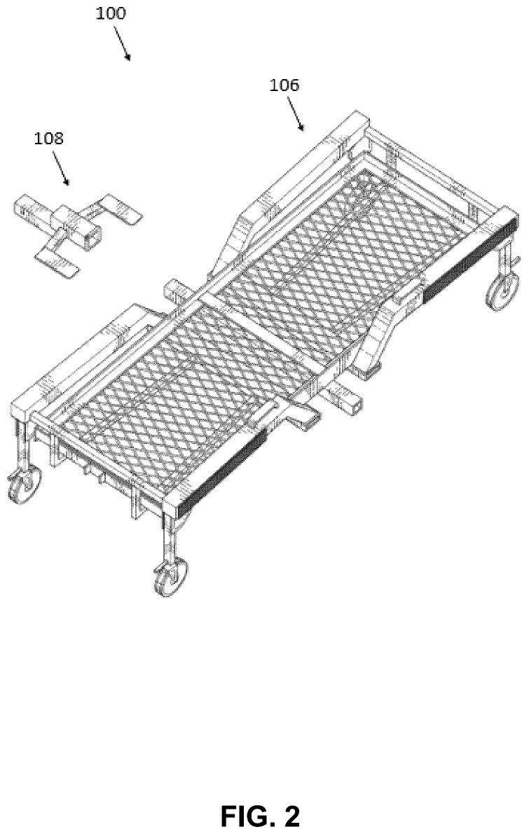

FIG. 2 is a perspective view of the wagon 106 and the hitch adaptor 108, in accordance with one embodiment, showing the wagon 106 without the attachable push handle 110.

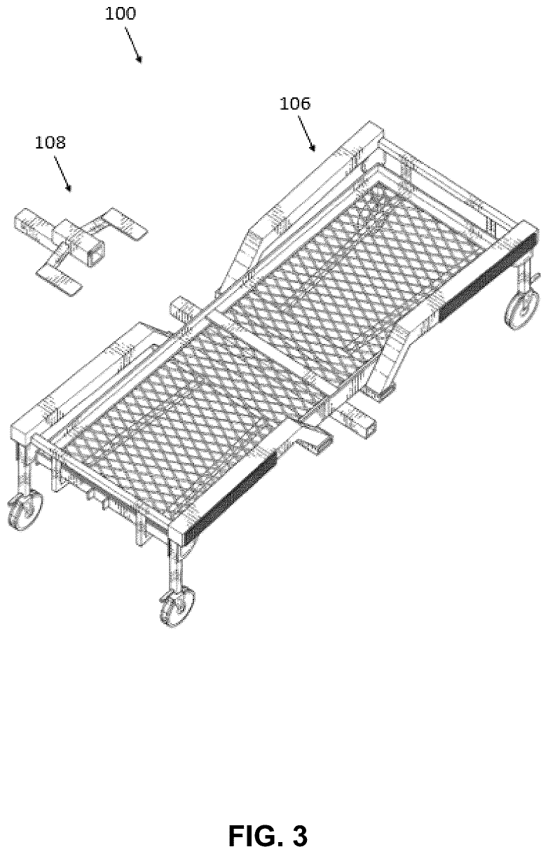

FIG. 3 is a perspective view of the wagon 106 and the hitch adaptor 108, in accordance with one embodiment, showing the wagon 106 without the attachable push handle 110 and without the one or more handles 112.

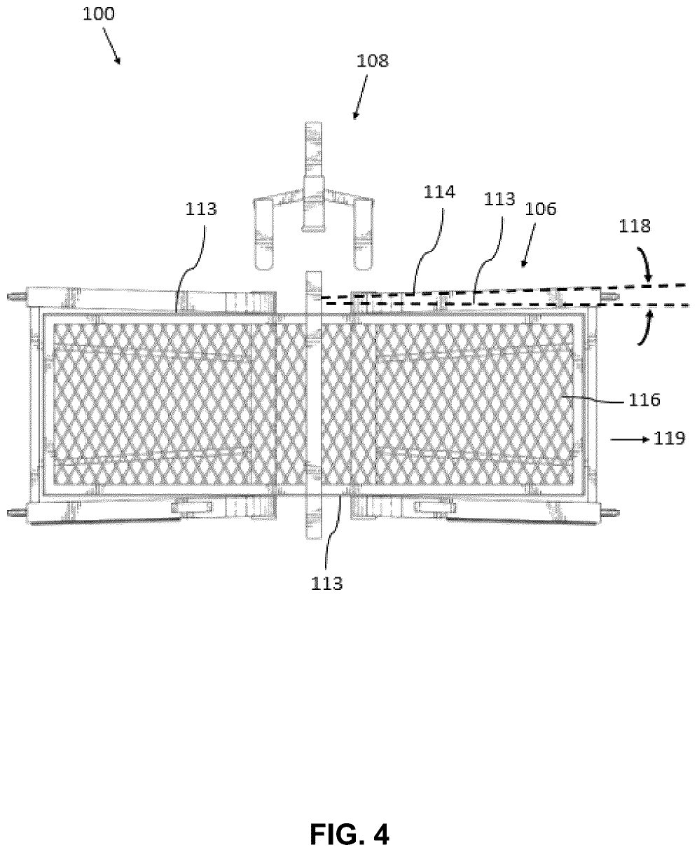

FIG. 4 is a top view of the wagon 106 and the hitch adaptor 108. The wagon 106 has a frame 114 in a bowtie shape. For example, the frame 114 may be off-set from an edge 113 of the basket 116 by an off-set angle 118. The off-set angle 118 may be 1° to 25°, 5° to 25°, 10° to 20°, or 15° to 20°.

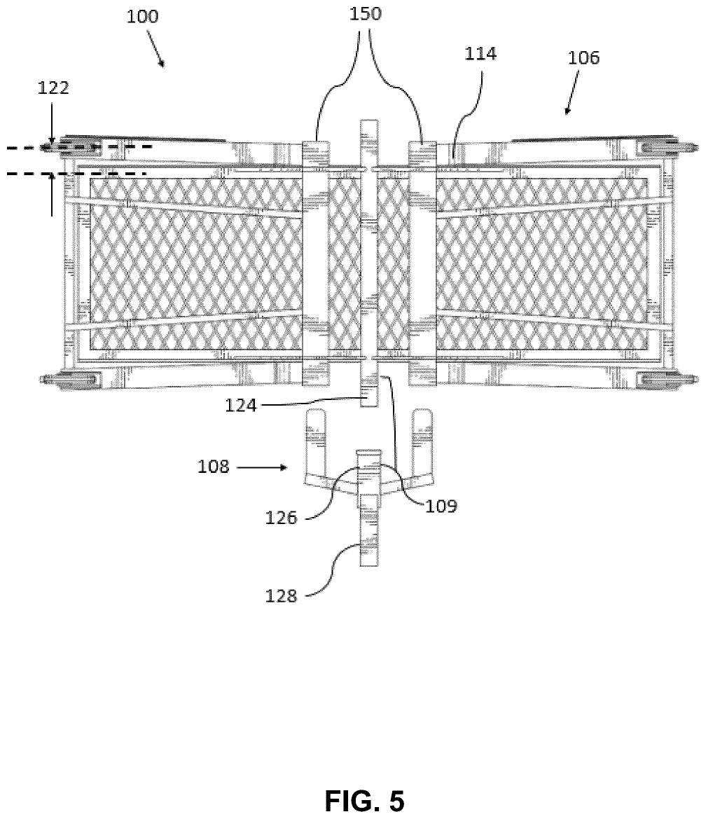

The off-set angle 118 is designed to provide several advantages. First, it provides a clearance distance such that the retractable wheels 132 in the fully retracted position do not contact the basket 116. FIG. 5 is a bottom view thereof. The bowtie shaped frame 114 is shaped for added wheel mechanism distance 122 (e.g., a distance between the edge of the basket 116 and the retractable wheels 132) such that the retractable wheels 132 when folded into the fully retracted position do not contact the basket 116. Because of the off-set angle 118, the retractable wheels 132 in the fully extended position (e.g., when the wagon 106 is on the ground) have a tendency to tilt and align with the edge of the bow tie shaped frame 114, e.g., a radial direction of the retractable wheels 132 is off-set from a normal pull direction 119. The off-set or tilt orientation of the retractable wheels 132 provides stability (e.g., not rolling around) when the wagon 106 is at its stationary position on the ground. When the wagon 106 is pulled, the rolling direction of the retractable wheels 132 aligns with the normal pull direction 119 such that the wagon 106 is easily pulled/pushed from its stationary/rest position. Without the off-set angle 118, the retractable wheels 132 have a tendency to align with the edge 113 of the basket 116, and when the wagon 106 is pulled, the retractable wheels 132 may pivot in opposite directions which creates a resistance for the wagon 106 to move in the normal pull direction 119.

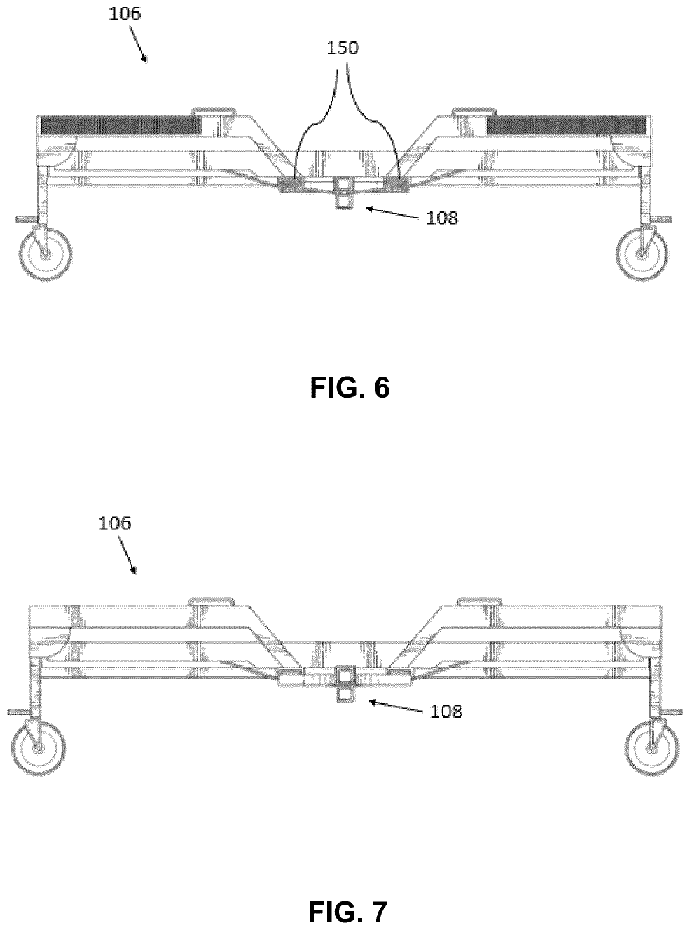

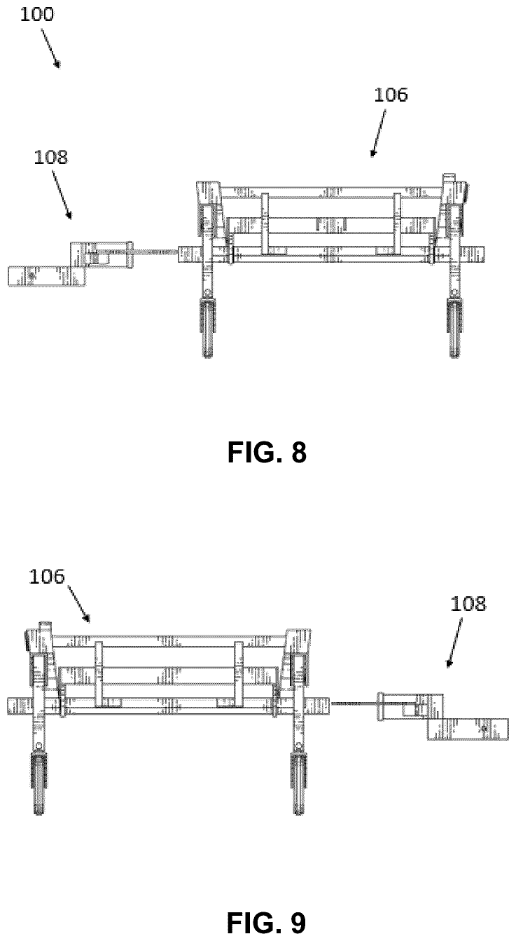

FIG. 6 is a right-side view thereof. FIG. 7 is a left-side view thereof. FIG. 8 is a rear view thereof. FIG. 9 is a front view thereof;

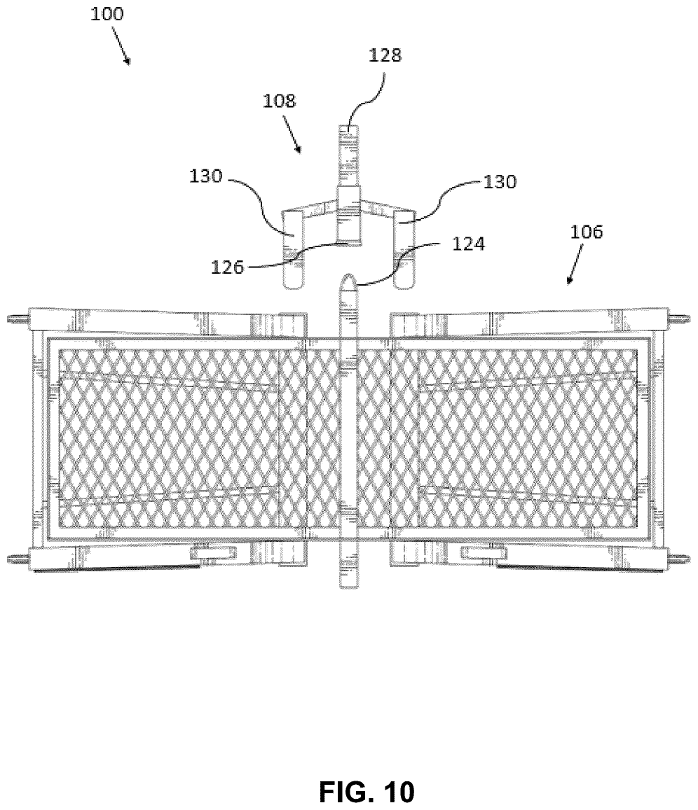

FIG. 10 is a top view of the wagon 106 and the hitch adaptor 108, in accordance with one embodiment, showing an insertion piece 124 of the wagon 106 receivable by the hitch adaptor 108. The hitch adapter 108 includes a first receiver extension 126, a second receiver extension 128, and a pair of forks 130. The insertion piece 124 may have any suitable cross-sectional shape, e.g., hollow or solid square, hollow or solid circle, hollow or solid triangle, etc. The insertion piece 124 may be tapered (as shown in FIG. 10) or may be straight. The insertion piece 124 is configured to be receivable by the first receiver extension 126 of the hitch adaptor 108. The tapered shape is configured to provide easier alignment between the wagon 106 and the hitch adaptor 108.

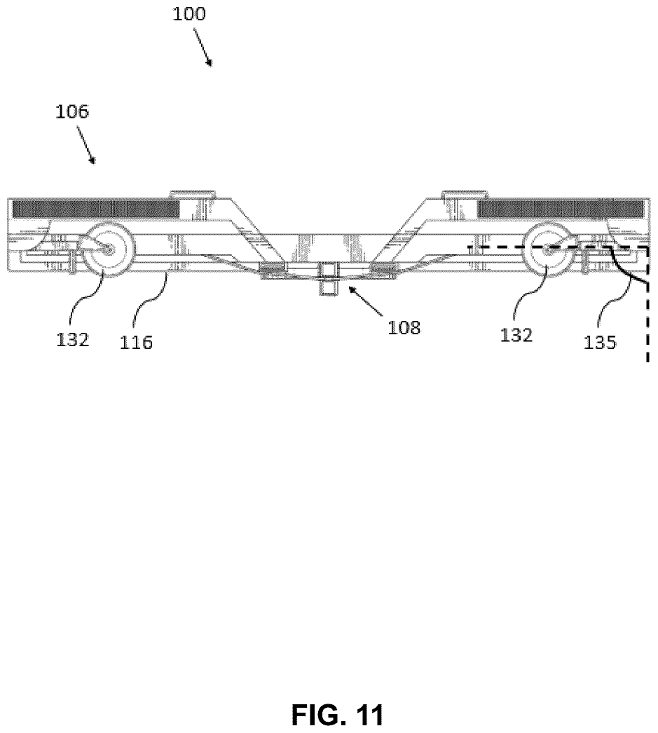

FIG. 11 is a right-side view of the hitch adaptor 108 and the wagon 106, in accordance with one embodiment, showing the four retractable wheels 132 of the wagon 106 in a retracted configuration. The four retractable wheels 132 are configured to pivot relative to the basket 116 between a fully retracted configuration and a fully extended configuration (as shown in FIGS. 6 and 7). It may be appreciated that the frame 114 with a bowtie shape provides clearance allowing the four retractable wheels 132 to be folded between the fully retracted configuration and the fully extended configuration with an about 90 degrees pivot angle 135. The four retractable wheels 132 in the fully retracted configuration, e.g., the pivot angle 135 is equal to or about 90° provide a ground clearance (distance to the ground), e.g., added or additional ground clearance compared to wheels that cannot be fully retracted.

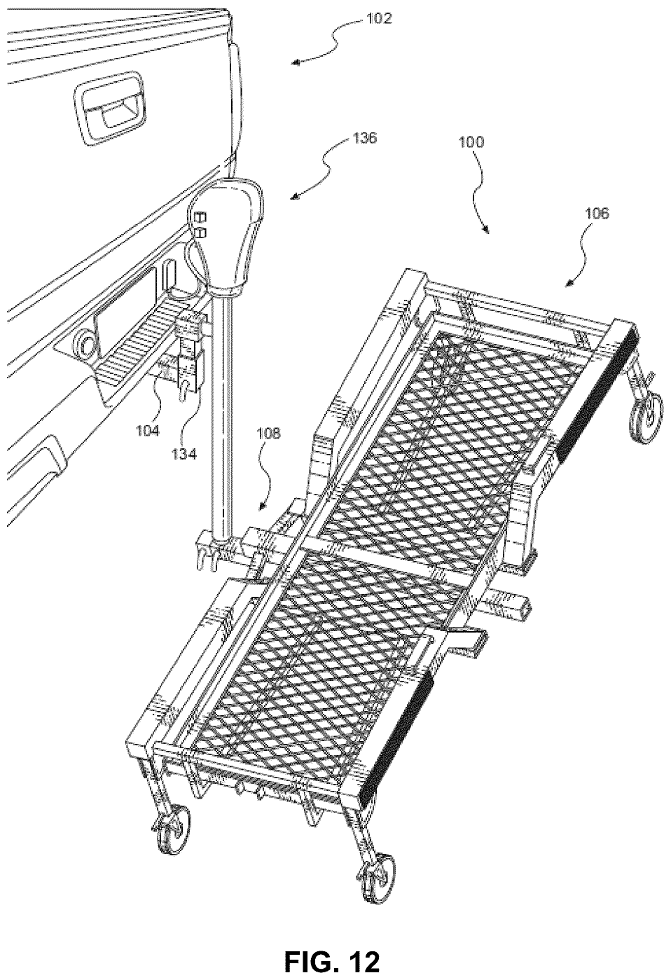

FIG. 12 is a perspective view showing the hitch adaptor 108, the wagon 106, and a connector 134 in a configuration of use where the hitch mountable wagon assembly 100 is in a lowered position. The connector 134 is configured to removably connect the wagon assembly 100 to the hitch receiver 104 and a hitch lift 136, e.g., a motorized hitch lift, a manual hitch lift, or a combination of both. In one example, the hitch lift 136 may be a power lift with about 3,500 pounds lift capacity or higher. In one example, the hitch life 136 may include a manual cranking handle that can be used in an event of power loss.

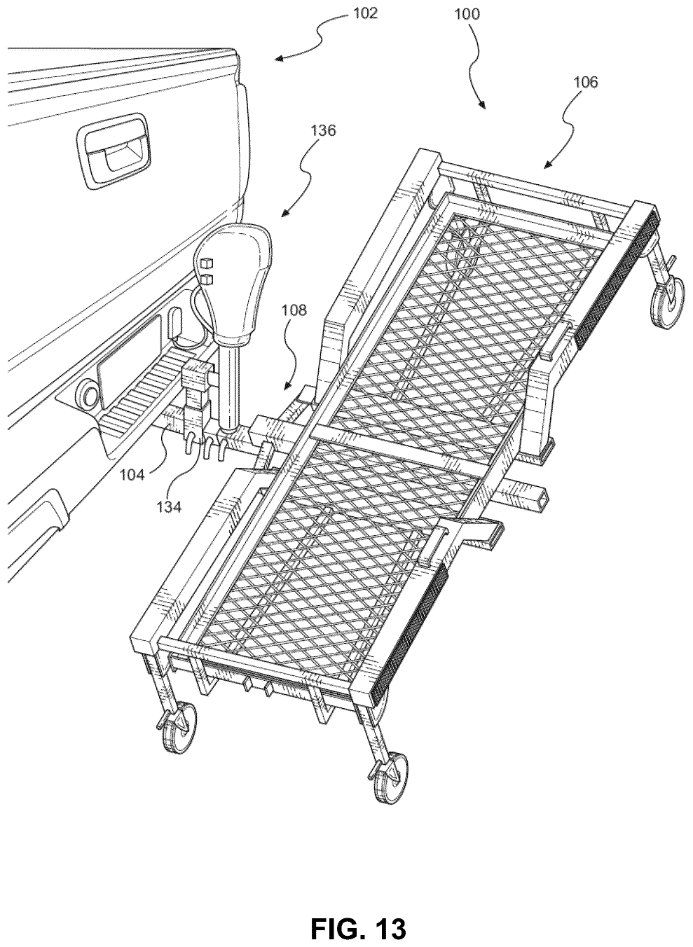

FIG. 13 is a perspective view showing the hitch adaptor 108, the wagon 106, and the connector 134 in a configuration of use where the hitch mountable wagon assembly 100 is in a lifted position.

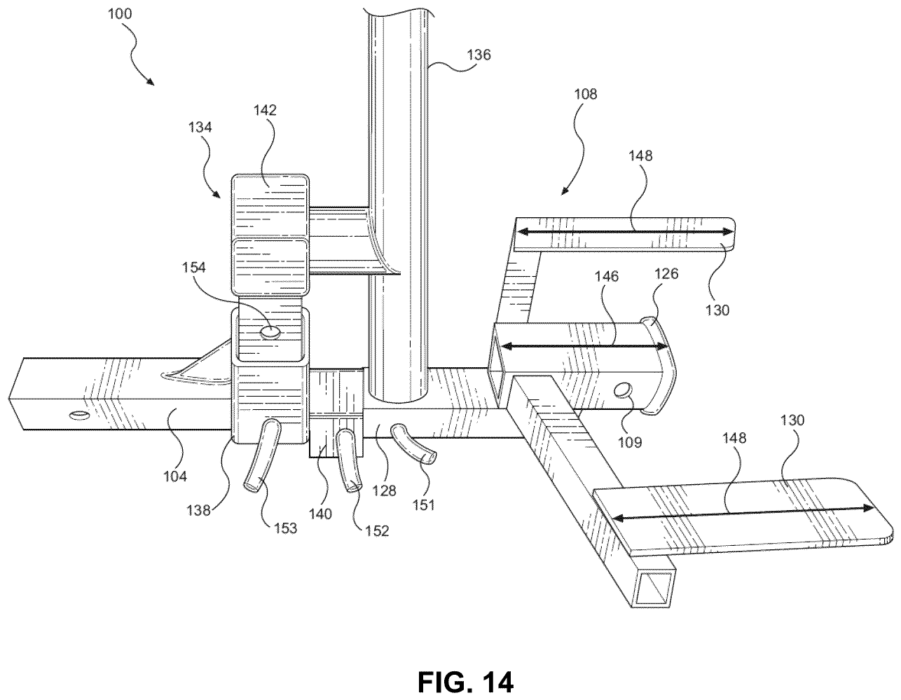

FIG. 14 is a perspective view showing the hitch adaptor 108 and the connector 134 in a configuration of use where the hitch mountable wagon assembly 100 is in a lifted position. The first receiver extension 126 and the pair of forks 130 protrude in the same direction (e.g., towards the wagon 106) and the second receiver extension 128 protrudes in the opposite direction (e.g., towards the hitch receiver 104). The first receiver extension 126 and the pair of forks 130 are in the first plane and the second receiver protrusion 128 is in a second plane below the first plane. In one example, the first receiver extension 126 and the second receiver protrusion 128 may be a tower hitch receiver adaptor with a 2 inches drop/rise, a 9 inch hitch extender, and a solid tube hitch riser.

The connector 134 may be a dual hitch receiver including a first connecting component 138 configured to removably connect/secure to the hitch receiver 104 and a second connecting component 140 configured to removably connect/secure to the second receiver extension 128. The connector 134 further includes a third connecting component 142 configured to removably connect/secure to the hitch lift 136.

Pins 151, 152, and 153 are used to secure the adopter 108, the hitch lift 136, and the hitch receiver 104 together. The pin 151 secures the adaptor 108 to the hitch lift 136. In particular, the pin 151 secures the adaptor 108 to an inner shaft of the hitch lift 136. When the inner shaft is extended, the hitch lift 136 is in a lowered configuration and when the inner shaft is retracted, the hitch lift 136 is in a raised configuration. The inner shaft of the hitch lift 136 may be telescoped up and down to lift and lowered the adaptor 108 when the pin 151 is in place. The pin 153 secures the hitch lift 136 to the hitch receiver 104. A pin hole 154 allows for a height adjustment of the hitch lift 136 and the adaptor 108 relative to the ground or relative to the hitch receiver 104. For example, if the pin 153 is inserted into the pin hole 154, the hitch lift 136 and the adaptor 108 are shifted down or lowered further towards the ground, which provides some extent of height adjustment when connecting the wagon 106. The pin 152 helps maintaining an alignment, e.g., a straight alignment, between the adaptor 108, the hitch lift 136, and the hitch receiver 104. When the pin 152 is in place, the hitch lift 136 is locked and cannot be raised or lowered. The pin 152 serves as a safety feature for traveling so that the hitch lift 136 is not able to accidentally lower or raise while the vehicle is moving.

The first receiver extension 126 has a length 146 and the pair of forks 130 have a length 148. The length 146 is shorter than the length 148. The length 146 may be about 30% to 90%, about 30% to 80%, about 40% to 70%, about 40% to 60%, or about 50% of the length 148.

The hitch adaptor 108 engages with the insertion piece 124 (e.g., a tubular structure) that extends from the side of the wagon 106. The insertion piece 124 is inserted and received by the first receiver extension 126. The pair of forks 130 are inserted and received by a pair of tubular structures 150 (see FIGS. 5 and 6) attached underneath the bottom of the wagon 106 (e.g., the bottom of the basket 116). Once the hitch adaptor 108 is fully engaged with the insertion piece 124 and the pair of tubular structures 150, a pin is inserted into a pair of pin holes 109 to secure the adaptor 108 to the wagon 106. For example, one pin hole 109 is through the tubular wall of the first receiver extension 126 and the other pin hole 109 is through at least a portion of the insertion piece 124 (or through a tubular wall of the insertion piece 124) such that when a pin is inserted through the pair of pin holes 109 the hitch adaptor 108 is secured to the wagon 106. The hitch adaptor 108 further includes the second receiver extension 128 (e.g., a tubular extension) that is sized to fit within the vehicle trailer hitch receiver 104.

The wagon 106 may be made of any suitable materials including metals and/or metal alloys (e.g., steel, aluminum, etc.), plastics, polymers, composites, or a combination thereof. In some embodiments, at least a portion of the wagon 106 may be formed via injection molding. The wagon 106 may be made of one or a combination of materials to achieve an effective mechanical strength while reducing the overall mass or density.

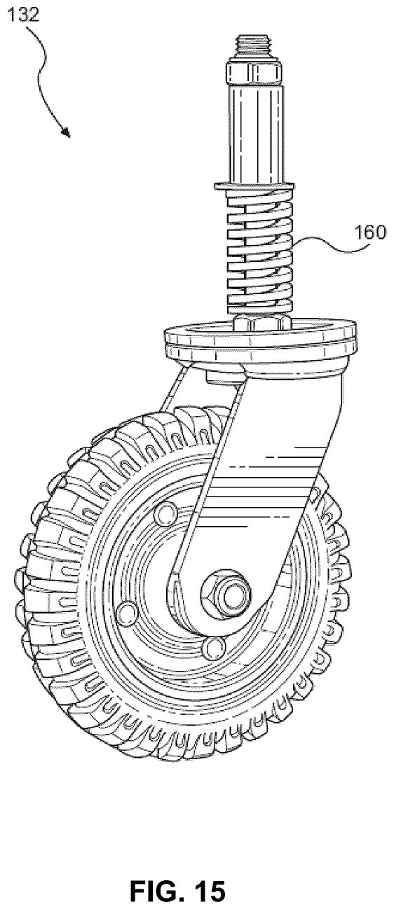

In some embodiments, the retractable wheels 132 are shock absorbing wheels. FIG. 15 shows an image of an exemplary retractable wheel 132. The retractable wheel 132 may be a shock absorbing caster wheel with a shock absorbing element 160, which may be a spring, a damper, a resistant element, etc.

A process of manufacturing the hitch mountable wagon assembly 100 includes assembling the wagon 106. The wagon 106 includes the basket 116, the frame 114 along a perimeter of the basket 116, the pair of tubular structures 150 attached underneath the bottom of the basket 116, the insertion piece 124 attached underneath the bottom of the basket 116 and between the pair of tubular structures 150, and four retractable wheels 132 mounted at four corners of the frame 114. The process includes assembling the adapter 108 configured to removably mount the wagon 106 to the hitch receiver 104 of the vehicle 102. The adapter 108 includes the pair of forks 130 insertable into the pair of tubular structures 150 of the wagon 106, the first receiver extension 126 between the pair of forks 130, configured to receive the insertion piece 124 of the wagon 106, and the second receiver extension 128 receivable by the hitch receiver 104 of the vehicle 102.

This written description sets forth the best mode of practicing the claimed invention, and describes the invention so as to enable a person of ordinary skill in the art to make and use the invention, by presenting examples of the elements recited in the claims. The detailed descriptions of those examples do not impose limitations that are not recited in the claims.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

In one aspect, a method may include an operation, an instruction, and/or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

The functions, acts or tasks illustrated in the Figures or described may be executed in a digital and/or analog domain and in response to one or more sets of logic or instructions stored in or on non-transitory computer readable medium or media or memory. The functions, acts or tasks are independent of the particular type of instructions set, storage media, processor or processing strategy and may be performed by software, hardware, integrated circuits, firmware, microcode and the like, operating alone or in combination. The memory may comprise a single device or multiple devices that may be disposed on one or more dedicated memory devices or disposed on a processor or other similar device. When functions, steps, etc. are said to be “responsive to” or occur “in response to” another function or step, etc., the functions or steps necessarily occur as a result of another function or step, etc. It is not sufficient that a function or act merely follow or occur subsequent to another. The term “substantially” or “about” encompasses a range that is largely (anywhere a range within or a discrete number within a range of ninety-five percent and one-hundred and five percent), but not necessarily wholly, that which is specified. It encompasses all but an insignificant amount.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112(f) unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A hitch mountable wagon assembly, comprising:
a wagon comprising:
a basket;
a frame along a perimeter of the basket;
a pair of tubular structures attached underneath a bottom of the basket;
an insertion piece attached underneath the bottom of the basket and between the pair of tubular structures; and
four retractable wheels mounted at four corners of the frame; and
an adapter configured to removably mount the wagon to a hitch receiver of a vehicle, wherein the adapter comprises:
a pair of forks insertable into the pair of tubular structures of the wagon;
a first receiver extension between the pair of forks, configured to receive the insertion piece of the wagon; and
a second receiver extension receivable by the hitch receiver of the vehicle.

2. The hitch mountable wagon assembly of claim 1, comprising a connector configured to removably connect the adaptor, the hitch receiver, and a hitch lift to one another.

3. The hitch mountable wagon assembly of claim 2, wherein the connector comprises a first pin configured to removably secure the adaptor to the hitch lift.

4. The hitch mountable wagon assembly of claim 2, wherein the connector comprises a second pin configured to maintain an alignment between the adaptor, the hitch lift, and the hitch receiver, and when the second pin is in place, the hitch lift is not able to lower or raise.

5. The hitch mountable wagon assembly of claim 2, wherein the connector comprises a third pin configured to secure the hitch lift to the hitch receiver.

6. The hitch mountable wagon assembly of claim 1, wherein the frame is in a bowtie shape.

7. The hitch mountable wagon assembly of claim 6, wherein the frame is off-set from an edge of the basket by an off-set angle between 1 degree and 25 degrees.

8. The hitch mountable wagon assembly of claim 1, wherein the pair of forks have a first length and the first receiver extension has a second length, the second length is shorter than the first length.

9. The hitch mountable wagon assembly of claim 8, wherein the second length is about 50% of the first length.

10. The hitch mountable wagon assembly of claim 1, wherein the insertion piece is tapered.

11. The hitch mountable wagon assembly of claim 1, wherein the four retractable wheels comprise two front wheels that are pivotable to change direction of the wagon.

12. The hitch mountable wagon assembly of claim 1, wherein each of the four retractable wheels comprises a handle for maneuvering the retractable wheel between a fully retracted position and a fully extended position.

13. The hitch mountable wagon assembly of claim 1, wherein the wagon comprises an attachable push handle.

14. The hitch mountable wagon assembly of claim 1, wherein the wagon comprises one or more handles.

15. The hitch mountable wagon assembly of claim 1, wherein the four retractable wheels comprise a spring and lock mechanism to secure the four retractable wheels in a fully retracted position or in a fully extended position.

16. The hitch mountable wagon assembly of claim 1, wherein the four retractable wheels are shock absorbing wheels.

17. The hitch mountable wagon assembly of claim 1, wherein the first receiver extension and the pair of forks are in a first plane and the second receiver extension is in a second lane below the first plane.

18. The hitch mountable wagon assembly of claim 1, wherein the wagon is made of materials selected from steel and aluminum.

19. The hitch mountable wagon assembly of claim 1, wherein at least a portion of the wagon is formed via injection molding.

20. A method of manufacturing a hitch mountable wagon assembly, comprising:
assembling a wagon comprising:
a basket;
a frame along a perimeter of the basket;
a pair of tubular structures attached underneath a bottom of the basket;
an insertion piece attached underneath the bottom of the basket and between the pair of tubular structures; and
four retractable wheels mounted at four corners of the frame; and
assembling an adapter configured to removably mount the wagon to a hitch receiver of a vehicle, wherein the adapter comprises:
a pair of forks insertable into the pair of tubular structures of the wagon;
a first receiver extension between the pair of forks, configured to receive the insertion piece of the wagon; and
a second receiver extension receivable by the hitch receiver of the vehicle.
